(19) United States
(12) Patent Application Publication
(10) Pub. No.: US 2026/0187090 A1
(43) Pub. Date: Jul. 2, 2026

(54) ADAPTIVE MAINTENANCE AND ENUMERATION OF ATTRIBUTE VALUES

(71) Applicant: International Business Machines Corporation, Armonk, NY (US)

(72) Inventors: Yuval Lifshitz, Kfar HaOranim (IL); Gabriel Zvi BenHanokh, Tel Aviv (IL)

(21) Appl. No.: 18/758,023

(22) Filed: Jun. 28, 2024

(51) Int. Cl. G06F 16/25

(52) U.S. Cl. CPC G06F 16/25

(57) ABSTRACT

Adaptive maintenance and enumeration of attribute values includes receiving attribute values for attributes of data objects, the received attribute values being non-enumerated values, maintaining at least some of the attribute values in data structure(s), which includes enumerating an attribute value, of the at least some of the attribute values, based on enumeration criteria, the enumerating including providing and storing an enumeration of the attribute value, and based on a request to perform an operation on a received attribute value, of a data object, for which an enumeration is maintained, using the enumeration of the received attribute value of the data object in performing the operation.

### BACKGROUND

Embodiments of the present invention relate to maintenance of data objects in data storage systems, and more specifically to efficient use of storage when maintaining attribute values for attributes of the data objects.

### SUMMARY

Shortcomings of the prior art are overcome and additional advantages are provided through the provision of a computer-implemented method. The method receives attribute values for attributes of data objects. The received attribute values are non-enumerated values. The method also maintains at least some of the attribute values in one or more data structures. The maintaining the at least some of the attribute values includes enumerating an attribute value, of the at least some of the attribute values, based on enumeration criteria. The enumerating includes providing and storing an enumeration of the attribute value. The method further includes, based on a request to perform an operation on a received attribute value, of a data object, for which an enumeration is maintained, using the enumeration of the received attribute value of the data object in performing the operation.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2A-2B depict example data structures for maintaining attribute data, in accordance with aspects described herein;

FIG. 3 depicts an example process flow for adaptive maintenance and enumeration of attribute values, in accordance with aspects described herein;

FIG. 4 depicts further details of example adaptive attribute value maintenance and enumeration code to incorporate and/or use aspects described herein; and

FIG. 5 depicts an example process for adaptive maintenance and enumeration of attribute values, in accordance with aspects described herein.

### DETAILED DESCRIPTION

Described herein are approaches for adaptive maintenance and enumeration of attribute values, including, for example de-duplication of values being maintained in an object storage system. Object storage systems store and manage many – sometimes millions or billions – of data objects. Data objects have attributes housed in metadata used for various functions. Often the metadata is stored in association with the data object, for instance as part of the object itself or with the data object, and includes multiple attributes about the data object. An attribute refers to a property, and is typically defined by a name (‘attribute name’, also referred to as a ‘key’ for the attribute or ‘name’) and a value (‘attribute value’, also referred to as the attribute ‘data’ or ‘value’).

Often the attributes names (keys) and attribute values are of variable length. Object store application programming interfaces (APIs), such as those of cloud storage platforms, allow sending of attributes as name-value pairs together with the data objects. It is common to provide an attribute name (key) as a datatype of ‘string’ and attribute value for the attribute as a datatype of ‘string’. The string datatype is an example of a non-enumerated value. It is common for the values held by these attributes to be defined as strings (or other non-enumerated values), for instance to allow for flexibility and extensibility of the associated protocol.

Any given attribute might have varying attribute values across different data objects, and therefore the practice of handling attribute names and value in string form may be performed for multiple attribute-value pairs. The number of different attributes and values can vary from one to any number. Most typically, the data objects being handled by an object storage system will span tens to hundreds of different/unique attributes, and thousands to millions of different/unique attribute values. The number of objects about which attribute are maintained may reach into the billions. By way of concrete example, a single data object could be an image file (e.g., a photograph captured by a user), attributes of the object could include a date taken, a file size, a location indicator, dimensions, resolution, bit depth, compression, color mode, various properties about the imaging device (F-stop, ISO equivalent, exposure time, focal length, flash mode, etc.), and properties about the owner/user. An object storage system might store billions of images with these and/or other attributes and values for each of these attributes. It is easily seen that maintenance of attribute information, including keys/names and values, involves billions of pieces of information, thus leading to potential inefficiencies in the maintenance and processing of the data.

Depending on the type of the attribute, the attribute values can come from a very limited range of values or a very broad range of values. Some attributes might have the same attribute value across many or all data objects (e.g., a Content-Type of ‘MIME type’), while some attributes might see a limited number of unique attribute values (e.g., an attribute for the encryption algorithm use might see only a few unique attribute values), while yet other attributes might see almost entirely unique attribute values for each data object maintained. For instance, some attributes might hold values that could be different for each object, for instance if the attribute is extremely fine-grained (like an md5 hash of the object, where the same hash for multiple objects is unlikely to occur). If the data objects are images and each have an attribute of ‘date taken’ (as the attribute name/key) that indicates a day/month/year (as the attribute value) the image was captured, then all images captured on the same day and stored to the object storage system will have the same attribute value for their ‘date taken’ attribute, across all users storing their images in the storage system.

User-defined attributes allow for even greater flexibility in terms of name and values. Similar to system-defined attributes, the values they hold could come from a limited or broad range. They may be different for each object or request, for instance.

Storing and working with data in string (and other non-enumerated) datatypes can have negative performance implications. Some require dynamic allocation, for instance, which comes with potentially negative impacts to performance and efficiency. For example, strings often need to be allocated, copied, compared, etc., and there are resource-related costs of this, which can be greater than those costs associated with working with enumerated values. Costs in memory resource usage, processing resource usage, and bandwidth resource (e.g., on the channel between client and server) can be greater when dealing with non-enumerated values than when dealing with enumerated values.

In short, some cloud infrastructures store and work with data as strings, which is costly in terms of working with those values. Aspects described herein provide approaches for enumerating some (or all) of these values, including decision-making as to which values to enumerate and store (i.e., in a numerical data type), and when to perform such enumeration. In disclosed approaches, attribute values may be enumerated, and these values may be values received (interchangeably referred to as ‘observed’ herein) for one or more attributes for which data is being maintained. In some examples, a server, such as a server of an object/data storage system, maintains a translation table of attribute values for various attributes, and adapts its decision-making in terms of determining whether and which values to enumerate based on whether an attribute and/or individual values would benefit from enumeration.

As noted, attributes are identified by attribute name (key; unique identifier) and are set to values that could vary across objects. There is a set of values that have been observed for each given attribute. When a server receives an attribute value for a new attribute, it can begin logging/storing the observed attribute values for that attribute. Any time an attribute value for that attribute arrives, and if value enumeration for that attribute is not indicated as being skipped, a process can look into an attribute values table or other data structure to determine whether the value has been seen previously, and update count(s) being maintained for that attribute value and/or the attribute for which that value was observed.

In one approach, a process maintains a list of attribute values seen for one or more attributes and tracks characteristics of the observation of the attribute values and attributes, for example tracks the numbers of times each of the attribute values were observed and the uniqueness of those attribute values relative a broader set of attribute values observed. An attribute value that meets some enumeration criteria, for instance is observed some threshold number of times, for instance a static number within a given amount of time or some number based on a percentage of the total number of instances of observing that attribute value, could be enumerated and pinned (persistently maintained). In examples, the enumeration of the value, i.e., a numerical representation, for instance an integer value, could be maintained and used indefinitely (e.g., until optionally deciding to un-enumerate the value) in the system, and translated if needed. Then, when an instance of that attribute value is observed in non-enumerated form – for instance along with a new data object for storage or in the context of an update to an existing stored data object, the enumeration of that value could be used in storing the data object and its attributes, and working with the attribute value, for instance to perform operations.

Example data structures include attribute values table(s) to store attribute values in one or more forms, for instance in non-enumerated, hashed, and/or enumerated form, and an attribute table (also referred to as attribute name table) to store attribute names/keys. To help ensure that the tables do not grow unbounded, there can be maximum sizes set for them. Once a table reaches its maximum size, then incoming new values could replace other, older, value(s) that are purged from the table, or the new values could be prevented from being added. In examples where a respective table of attribute values is maintained for each attribute, then if the attribute values table reaches the maximum size and does not contain any enumerated values, the table could be deleted and the corresponding attribute marked as “non-enumerated”, in which case enumeration processing could be avoided/bypassed when encountering instances of that attribute in the future. These and other aspects are described in further detail herein.

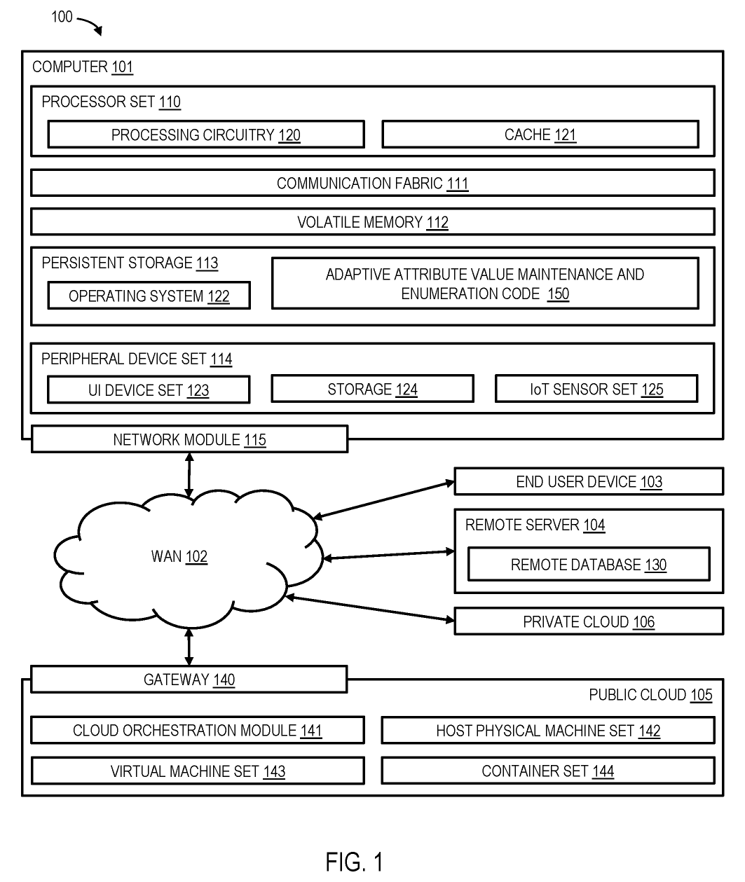

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as adaptive attribute value maintenance and enumeration code 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services and/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

When working with data objects, for instance in performing actions to receive, store, or update data objects, a process will receive/observe attribute data for those objects, including attribute names (keys) and attribute values for the attributes identified by those attribute names. A basic example is receipt of a new data object and associated metadata to store in an object storage system. Due to characteristics of non-enumerated values, for instance the fact that strings are generally of varying lengths, this can make it difficult or impossible to understand the layout of the messages/data structures storing the attribute data. For this and other reasons conventional deduplication approaches to de-duplicate these values in the system do not provide a satisfactory approach to deduplication in these situations.

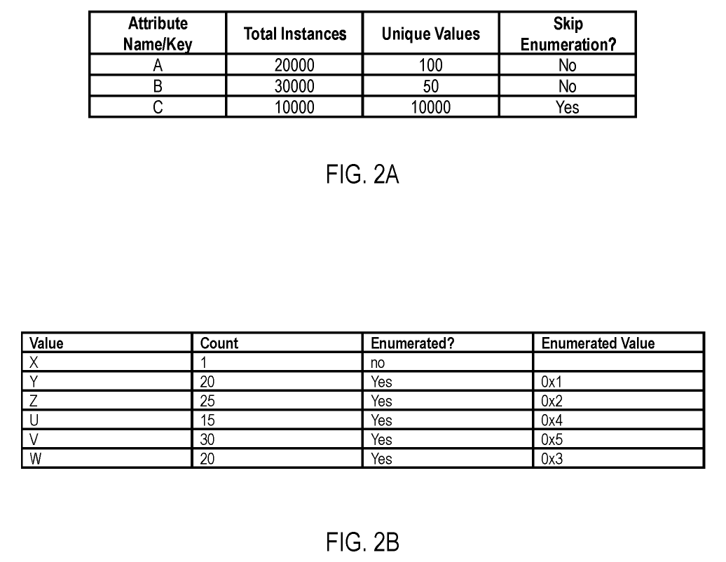

In accordance with aspects described herein, a process receives attribute values in non-enumerated form for attributes of data objects, and maintains some or all of these attribute values and associated names (keys) in data structure(s). FIG. 2A-2B depict example data structures for maintaining attribute data, in accordance with aspects described herein. The data structures are tables in these examples, though other types of data structures, such as linked-lists, could be used instead.

FIG. 2A depicts an example attribute names table and FIG. 2B depicts an example attribute values table, also referred to as a translation table. With reference initially to FIG. 2A, the top row is a header row in which each cell identifies the data maintained in its corresponding column. The first column identifies the key (attribute name) of each attribute being tracked. Each attribute name corresponds to a respective attribute. In this example there are three such attributes, but in practical examples there could be any number. In some applications, this number could be in the tens, hundreds, or thousands. Not all data objects maintained in the system would necessarily include an attribute for each attribute identified by the table, as different types of data objects might have different associated attributes.

The attribute name table includes, for each attribute name, two counts and an enumeration flag. A first count is the total number of instances that any attribute value for the attribute, regardless what the value was, was received/observed beginning from some point in time (the point in time being, for example, when the attribute was first observed). In the example of attribute named ‘B’, the system has observed 30,000 instances (for instance received data objects for storage) in which some attribute value was provided for that attribute identified by attribute name ‘B’. A second count is the number of unique attribute values received/observed for the attribute. For attribute ‘B’, this count is 50. Thus, in this example, there were 30,000 instances in which any attribute value for attribute ‘B’ was observed, but only 50 different attribute values for that attribute were observed across those 30,000 instances. In contrast, 10,000 instances of attribute ‘C’ were observed and 10,000 of them were unique relative to the others. In other words, no attribute value observed for attribute ‘C’ was repeated. The uniqueness of the attribute values for attribute ‘B’, which can be measured as a ratio of the two counts, is much lower.

An enumeration flag is also maintained for each of the attributes named in the table. The enumeration flag indicated for an attribute name indicates whether enumeration processing relative to the attribute is being skipped, i.e., whether to skip enumeration of attribute values of the attribute per se. The data maintained in the attribute names table will be further explained below.

FIG. 2B depicts an example attribute values table. The attribute values table indicates attribute values, counts maintained for each of those, enumeration indicators, and enumerations of attribute values that are enumerated in the system. In this example, the table includes any attribute value observed for any of the three attributes tracked in the attribute names table (FIG. 2A). In other examples, a respective attribute values table could be maintained for each attribute provided in the attribute names table, in which case there would be at least two attribute values tables provided – one for each of the two attributes for which enumeration is not being skipped, i.e., ‘A’ and ‘B’, and there could optionally be a third attribute values table (for attribute name ‘C’) that is no longer in use.

The top row of the attribute values table of FIG. 2B is a header row in which each cell identifies the data maintained in its corresponding column. The first column identifies each attribute value being tracked. It is possible that not all attribute values received/observed are necessarily being tracked. In any case, attribute values may be maintained in the attribute values table as non-enumerated values and/or hash values (described in further detail below). In this example, there are six attribute values indicated in the table, but in practical examples there could be any number. In some applications, this number could be in the millions or billions.

The attribute values table also includes, for each attribute value, a count of a number of instances that the attribute value was received/observed and an enumeration indicator indicating whether the attribute value is enumerated. If a given value is enumerated, then the enumeration (enumerated value) is also provided in the row corresponding to that attribute value. In this example, five of the six values are enumerated. The data maintained in the attribute values table will be explained in further detail below.

In examples such as the example of FIG. 2B where attribute values for various attributes are maintained together in a table, this provides an opportunity to gain efficiency by providing attribute value tracking across attributes. An attribute value could be valid and used for different attributes. For instance, an attribute value of a given date (day/month/year) might be observed across multiple different attributes, for example a ‘graduation date’ attribute and a ‘birth date’ attribute. It might be desired to track usage of the attribute value across all attributes and enumerate it on account of how often it is used regardless of whether it is observed often with respect to just one attribute or multiple of the attributes. This could be useful in situations where the attribute value does not meet enumeration criteria for any one of the attributes for which it was observed, but when considering the aggregate number of times this value is observed across all attributes, the system could benefit from enumerating the value.

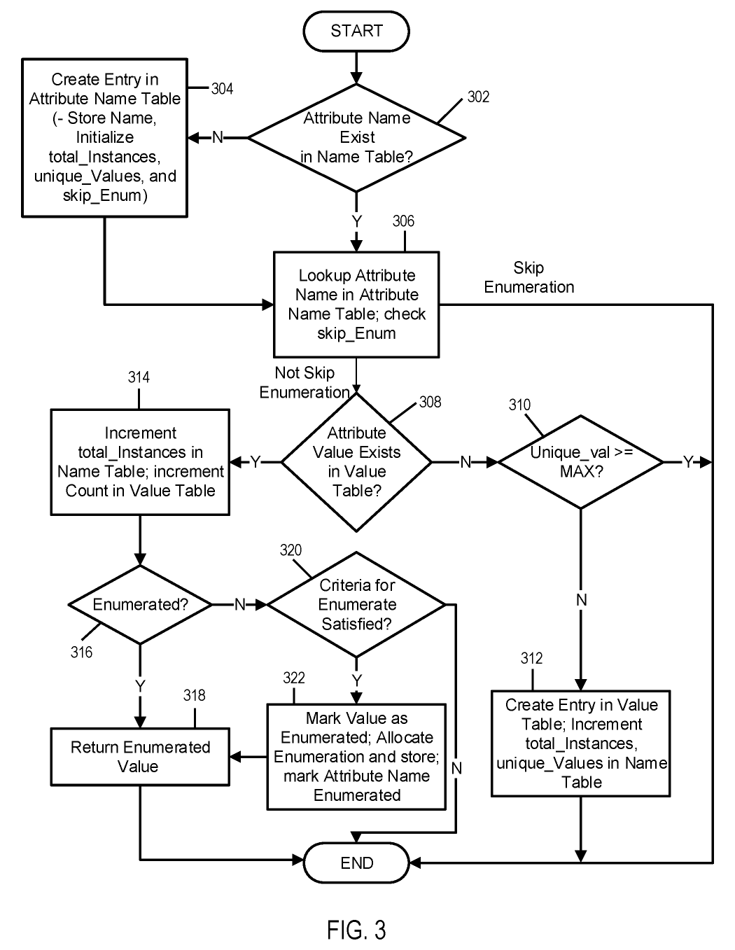

An attribute, identified by attribute name in the attribute names table, for which enumeration is skipped (Skip Enumeration = YES) means that the system is skipping enumeration processing in the context of that attribute. Since enumeration of attribute ‘C’ is being skipped, observation of attribute values for attribute ‘C’ will not trigger enumeration processing, which is described in further detail below with reference to FIG. 3. In the case of attribute ‘C’, none of the 30,000 attribute values observed over a period of time have been repeated, as all 30,000 are unique from each other. In this case, it may have been decided to skip enumeration processing for this attribute because any efficiency gained from enumerating the values for that attribute is not worth the enumeration processing involved in processing each received attribute value. Even if there were occasional repetitions of an attribute value, the resource consumption to undertake enumeration processing whenever any attribute value for the attribute is observed might be greater than the resource savings gained by enumerating the attribute value.

The enumeration processing is not skipped in the context of attributes ‘A’ and ‘B’ in this example. This is because there continues to be a significant-enough repetition in terms of the attribute values observed in instances of those attributes. When there is significant-enough repetition, then this is a good opportunity to enumerate the attribute values. Thus, their Skip Enumeration flag is set to NO so that every instance in which an attribute value for attribute ‘A’ or ‘B’ is received/observed will trigger enumeration processing, which involves a check for the presence of the attribute value in the attribute values table and for potential enumeration if not already enumerated.

In examples, attributes that are newly observed or otherwise not in the attribute names table (‘new attributes’) are marked for enumeration processing (Skip Enumeration = NO) to occur, at least initially. After some amount of time, number of observed instances of values for that attribute, or other parameter(s), the uniqueness level of the attribute values received for that attribute and/or other conditions can be checked, and the question whether to skip enumeration can be revisited. For example, if, after receiving some defined number of instances of attribute values for that attribute, it is determined that the uniqueness of those attribute values is too high, then the enumeration flag can be set to indicate to skip enumeration processing on subsequent observations of that attribute, since it may be deemed a waste of resources. In the case of attribute ‘C’ in FIG. 2A, the uniqueness is 100%, though any uniqueness threshold – say 60% – could be used for controlling whether to skip enumeration processing.

The question of whether to skip enumeration for a given attribute name can be revisited as often as desired and using any desired criteria for determining whether to maintain the enumeration flag as-is or to change the enumeration flag.

It is possible that not all attribute values observed are being maintained in the attribute values table(s). For example, the attribute values for an attribute for which enumeration processing is being skipped may not be logged into the attribute values table. On the other hand, it is possible that an attribute value is observed at one point in time for a first attribute for which enumeration processing is being skipped but at another point in time for a second attribute for which enumeration processing is not being skipped. In this case, the value might be in the attribute values table, and potentially might be enumerated, despite not tracking that attribute value in the context of the first attribute since enumeration processing is skipped for that attribute. In this case, the enumeration flag for the first attribute could, if desired, be changed to enable enumeration processing for that first attribute on account that at least one of the attribute values seen for that attribute is/are already being enumerated.

Referring to the attribute values table of FIG. 2B, attribute value X has a count of 1, meaning that the attribute value has been received/observed once since some point in time (potentially since the first time the value was observed with respect to any attribute ‘A’, ‘B’, or ‘C’). This value X is not being enumerated in this example because it has not met some one or more criterion (“enumeration criteria” herein) for enumerating the value. In this regard, as part of maintaining attribute values, a process can determine whether to enumerate an attribute value based on enumeration criteria and a count of the number of instances that the attribute value was received/observed. Here, the count is 1. An example enumeration criteria is a simple threshold, for instance a count of 10. This criteria will operate to enumerate the value once this attribute value is observed 10 times. The value would be indicated as enumerated in the table column (Enumerated? = YES), and the enumeration of the value would also be indicated in the Enumerated Value column. Then, when a request is made to perform an operation on that attribute value, for instance if observing an instance of that value in a new data object for storage, the enumeration of the value can be used in performing the operation – storing the data object and attributes thereof – rather than the non-enumerated value. As an example, if an incoming data object has an attribute with a non-enumerated attribute value that has been enumerated in the system, then the enumeration, instead of the non-enumerated value, can be stored when storing that data object.

Enumeration criteria could be more complex than this basic example. For instance, the enumeration criteria could incorporate a timing aspect that controls whether the attribute value is enumerated based at least in part on a lapse of an amount of time tracked by a timer or other mechanism. In one example, a timer is started upon first receiving the attribute value, and the value will be enumerated if that attribute value is received a threshold number of times before lapse of the timer. In another example, a caching mechanism is used that is based on recency of observing instances of the attribute value and other attribute values. For example, a cache could be implemented that ages-out cached attribute values over time, if not observed again, as new attribute values are observed and added to the cache. If a value is observed before aging-out, it could be refreshed in the cache, for instance moved to a head of the cache. For instance, when any value is observed, it may be placed at a front/head of a cache and push all other values back in the cache. The oldest-observed value may be discarded and thus age-out. Then, a value in the cache can be enumerated if it remains therein upon some trigger, for instance lapse of a timer or upon being received/observed a threshold number of times without having aged-out. Other enumeration criteria using caches are possible. A least-recently-used (LRU) cache could be employed that ages-out the least recently used values as new values are received. Yet another approach uses the aging-out of a value as a trigger to check a count of the number of times the attribute value was observed during the time it spent in the cache, and the value may be enumerated if this number is more than or equal to some threshold.

In a particular example, a threshold is set at which an attribute value is enumerated. Using an example threshold of 10, a decision may be made to enumerate the value once 10 instances of the value are observed. The first 10 observed instances of the value could use the non-enumerated value, but then subsequently-received instances will use the enumerated value. A counter could be used to track this, where the count increases to the threshold (to trigger enumeration) and then increments or decrements by 1 each time another instance is observed or an object using the enumerated value is removed/deleted from the system, respectively. If the count decreases back to the threshold, then the count could optionally be reset to zero at that point. Optionally the value could be treated as non-enumerated, and the process could repeat to again await another 10 instances of the value before enumerating it. In embodiments, a mechanism exists to assure that enumerations already in use are not lost.

Optionally, after a value becomes enumerated, a process could identify maintained instances of the attribute value in non-enumerated form and replace the non-enumerated value with the enumeration – either the numerical value itself or a reference to the numerical value as a way of de-duplicating the value.

In an approach for maintaining the data structures storing attribute data, there exists two different tables for maintaining attribute values – one table for values that are being tracked for potential enumeration, and one for values that have been enumerated. This might be useful for reasons of persistency – enumerations of attribute values could be made persistent in non-volatile storage in order to maintain the translation between the attribute value in non-enumerated form and the value in enumerated form. Meanwhile, values that have not yet been enumerated may be considered more expendable and could be stored in temporary (e.g., volatile) storage.

Optionally, attribute values could be hashed for purposes of efficiency and minimizing storage consumption. For instance, non-enumerated attribute values could be hashed and then maintained in the temporary table in hashed form, if desired. This can help reduce storage consumption in situations where attribute values are relatively large.

FIG. 3 depicts an example process flow for adaptive maintenance and enumeration of attribute values, in accordance with aspects described herein. The process can be initiated upon receiving/observing an attribute and value thereof value, for instance upon receipt of a data object for storage or a changed attribute value of an existing data object, as examples. In any case, a data object has various attributes and values thereof, and therefore the process could be performed for each such attribute value that is received/observed. In examples, the process is performed by one or more computer systems, for instance a computer system of a cloud-based data object storage system.

The process determines (302) whether the attribute name/key exists in the attribute names table. If this is a new attribute name that does not exist in the table(302, N), the process continues to 304 to create an entry/row in the attribute names table to store the attribute name/key. It stores the attribute name and initializes total-Instances, unique_Values, and skip_Enum variables (those seen in FIG. 2A for example). Specifically, the two counts may be initialized to zero and the ‘Skip Enumeration?’ variable may be set to NO to indicate that enumeration processing is not to be skipped. In this regard, the attribute name is indicated as being open to potential attribute value enumeration, even though this first observed value for that attribute is not necessarily going to be enumerated at this point or at all.

After creating the entry, or if instead at 302 it was determined that the attribute name exists in the attribute names table (302, Y), the process continues to 306 to lookup the attribute name in the attribute names table and check the enumeration indicator. If enumeration processing is to be skipped (e.g., Skip Enumeration == YES), then the process ends at that point, as enumeration processing relative to values received for that attribute name is not to be performed. In examples where the attribute values are hashed, this cost to perform the hashing of the value may thus be avoided.

If instead at 306 enumeration processing is indicated as not to be skipped (e.g., ‘Skip Enumeration?’ == NO), the process continues to 308 to determine whether the attribute value observed for the attribute name exists in the attribute values table(s). This checks whether it is the first instance of observing this attribute value, either globally across attributes or for this specific attribute name. If the attribute value does not exist in the table(s) (308, N), then the process determines (310) whether an attribute values table storage maximum has been reached. This maximum could be, as examples, a threshold number of unique values already stored in the table or a threshold storage size of the table. If the storage maximum of the attribute values table has been reached, the process can end at that point without further processing of the attribute value. In examples where an attributes value table is maintained per attribute, then a determination may be made at that point as to whether any attribute value for the attribute name has been enumerated. If no attribute value for the attribute name has been enumerated despite having reached the storage maximum for that table, then it may be determined that enumeration of the attribute values for that attribute is not efficient. All of the entries in the table can be deleted and the attribute name can be indicated to skip enumeration processing. In such a situation, this could mean that the attribute values observed for the attribute tend to be relatively unique and enumeration processing may not be beneficial.

If instead the attribute values table storage maximum has not been reached (310, N), the process continues to 312 to create an entry/row for the attribute value in the attribute values table, initialize this attribute value count in the attribute values table to 1, initialize the enumeration indicator (e.g., ‘Enumerated?’) to NO in the attribute values table, and increment Total Instances and Unique Values for this attribute name in the attribute name table. This starts tracking the value for potential enumeration.

If instead at 308 it is determined that the value already exists in the attribute values table (308, Y), then the attribute value has been previously observed. The process increments (314) total_instances (e.g., total instances of the attribute name in the attribute name table) and the count in the attribute values table, then checks the enumeration indicator in the attribute values table to determine (316) whether the value is enumerated. If so (316, Y), the process returns (318) the enumeration (enumerated value or reference thereto) of the attribute value, for instance to use in storing the received data object prompting the processing of FIG. 3. Optionally, a separate count may be maintained to indicate the number of instances where the enumeration of the value is used in the system, and this count could be incremented at this point. If at some later time the enumeration of the value is removed or changed for a data object, for instance it is changed to another value or the associated data object is deleted, then this count could be decremented.

If instead it is determined at 316 that the value is not already enumerated (316, N), the process determines (320) whether criteria for enumeration is satisfied. If so, (320, Y), the process continues to 322 to mark the value in the attribute values table as being enumerated (e.g., ‘Enumerated?’ = Y), allocate an enumeration and store this in the attribute values table, and mark the attribute name/table as being enumerated if not already marked as such. After enumerating at 322, the process proceeds to 318 to return the newly enumerated value for storing in association with the data object being processed, and ends. If instead at 320 it is determined that the criteria for enumeration has not been satisfied (320, N), then the process ends.

As noted, various enumeration criteria may be used to determine whether to enumerate a given attribute value. In examples, the criteria incorporate a timing aspect, for instance one that enforces a requirement as the amount of time taken to reach a threshold count. In a specific example, a caching mechanism with any desired aging scheme is used to enforce a window of time, either based on a discrete amount of time tracked with a timer or based on arrival of subsequent attribute values and the effect that has on pushing out earlier-received attribute values, as examples. The cache itself could be a limited-space FIFO (first-in, first-out) buffer, cache, queue, or the like. In a specific example, reaching a threshold count of the number of instances of an attribute value before or when that value ages out of the cache can trigger enumeration of the value, and failure to reach that threshold count by the time the value ages-out could mean that the value is not enumerated at that time, in which case associated count(s) and/or timer(s) could be reset or reinitialized at that time or upon a next observation of the value to repeat the tracking of the value for potential later enumeration. Additionally or alternatively, observing an instance of a value already in the cache could move that value to a head or beginning of the cache as a way of keeping relatively frequently-observed values in the cache.

In other examples of enumeration criteria, whether to enumerate an attribute value could be based at least in part on the proportion of the number of instances of observing the attribute value for an attribute to the number of instances of observing any attribute value for the attribute. If that attribute value is a significant enough proportion of all attribute values seen for that attribute, this could trigger enumeration of the attribute value. For instance, if for a given attribute value is seen 200 times out of the 250 total times any value is seen for a given attribute, then this proportion (4/5 = 80%) could exceed a set threshold for enumerating the value.

It is possible, and entirely optional, that a value may be returned to non-enumerated status at some point after being enumerated. For example, the enumerated value could be removed from data structure(s) used for enumeration tracking and/or from storage where it is stored with existing stored data object(s). In a specific example, a count is maintained as to how many enumerations of a given attribute value are used/stored in the system so that the count is incremented each time the enumerated value is stored in association with a data object and is decremented every time a stored data object is removed/deleted from the system and that data object used the enumerated value. The count could be maintained in the attribute values table, for example. Once that count reaches a non-enumeration threshold, which could the same threshold or a different threshold than an enumeration threshold that triggered enumeration, the enumeration of the attribute value could be discarded, for instance by discarding the entry for the attribute value in the attribute values table. The storage space associated with maintaining that enumerated value and the other data in the entry can be freed/deallocated. Optionally, a mechanism could exist to assure that enumerations already in use are not lost.

As noted above, some examples involve calculating and storing a cryptographically strong hash for observed attribute values. Maintaining the attribute values in a table could thus mean storing the hash in the table rather than storing the non-enumerated value itself. Hashing the attribute values might be beneficial because the values themselves might be relatively large and consuming of storage space while a hash might be significantly smaller in terms of data consumed to store it.

Additionally or alternatively, the size of the enumerations (numerical values) could be fixed and limited, for instance fixed to be n bytes. An example fixed size of four byes (32-bits) would provide, for example, over 4 billion unique numerical values (as unsigned integers).

Hashing and/or limited-size enumerations could help reduce storage/memory demand on the server, simplify the data structure schemes on both the server and client (by using fixed-size relatively small, e.g. 4-byte, values instead of a variable-length strings), and reduce network traffic as it would reduce passage of relatively long attributes.

Also as noted above, multiple attribute values tables could be used. For example, a unique attribute values table could be maintained for each attribute. In either situation, the attribute values table(s) could be shared among sources or owners of the data objects (such as individual users or clients). In this regard, a many-to-one model is realized, in which multiple such users/clients could access a single server with the storage of their data objects using the same enumerated values.

Aspects described herein accordingly provide opportunities for deduplication of attribute values, for instance deduplication for attribute values that have been enumerated. The non-enumerated attribute values can be replaced with enumerations of those values, for instance with references to a single copy of the enumerated value. Deduplication can thus avoid storage of each instance of an attribute value, and instead replace each instance with a reference to a single instance, e.g., the enumeration of the value.

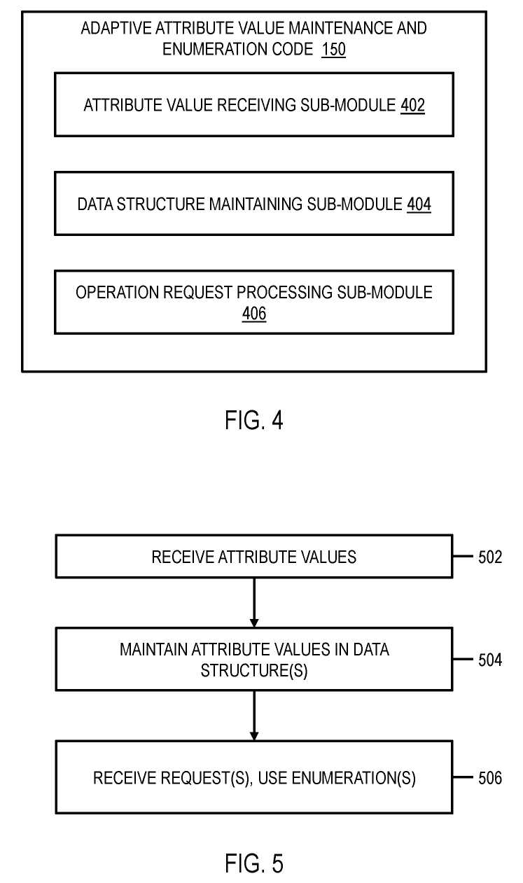

FIG. 4 depicts further details of example adaptive attribute value maintenance and enumeration code (e.g., adaptive attribute value maintenance and enumeration code 150 of FIG. 1) to incorporate and/or use aspects described herein. In one or more aspects, adaptive attribute value maintenance and enumeration code 150 includes, in one example, various sub-modules to be used to perform adaptive attribute value maintenance and enumeration. The sub-modules are, e.g., computer readable program code (e.g., instructions) in computer readable media, e.g., storage (persistent storage 113, cache 121, storage 124, other storage, as examples). The computer readable storage media may be part of one or more computer program products and the computer readable program code may be executed by and/or using one or more computing devices (e.g., one or more computers, such as computer(s) 101, computers of cloud 105/106, and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

Referring to FIG. 4, adaptive attribute value maintenance and enumeration code (150) includes attribute value receiving sub-module (402) for receiving (for instance obtaining, reading, fetching, etc.) attribute values for attributes of data objects, data structure maintaining sub-module (404) for maintaining data structure(s), including data structure(s) for maintaining attribute values (e.g., attribute values table(s)), and operation request processing sub-module (406) for receiving request(s) to perform operation(s) on attribute value(s) and, based on a request to perform an operation on a received attribute value for which an enumeration is maintained, use the enumeration of the received attribute value in performing the operation.

FIG. 5 depicts an example process for adaptive maintenance and enumeration of attribute values, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 5 are part of a module, such as code 150. In other examples, the code may be included in one or more modules and/or in one or more sub-modules of the one or more modules. Various options are available.

The process of FIG. 5 includes receiving (502) attribute values for attributes of data objects, for example by observing incoming data objects with attributes and/or requests for operations to store, read, or update attributes of data objects. The received attribute values may be non-enumerated values. The process also includes maintaining (504) at least some of the attribute values in one or more data structures. In examples, the attribute values being maintained are those for attributes for which enumeration processing described herein is not being skipped. The maintaining of the at least some of the attribute values includes enumerating an attribute value, of the at least some of the attribute values, based on enumeration criteria. The enumerating includes providing and storing an enumeration of the attribute value. In practical examples, this enumerating may be performed for many different attribute values.

The enumeration criteria is used to determine whether to enumerate any given attribute value, and therefore contributes to controlling whether a given attribute value will be enumerated. It is possible that some attribute values for an attribute will be enumerated while other attribute values are not. This might depend on factors like how often the attribute value is observed. Accordingly, information about each attribute value can be retained in the data structure(s). In some embodiments, maintaining the attribute values further includes maintaining, for each of the at least some of the attribute values (i.e., those being maintained in the structure(s)), (i) a count of a number of instances that the attribute value was received and (ii) an enumeration indicator indicating whether the attribute value is enumerated. Maintaining the attribute value can further include determining whether to enumerate the attribute value based on the enumeration criteria and the count of the number of instances that the attribute value was received. The result of this determination can be reflected by the enumeration indicator. Thus, in this regard, the enumeration criteria is used in conjunction with the count of the number of instances that the attribute value was received to determine whether to enumerate the attribute value.

In a basic approach, the criteria might dictate that the count is to be at least some threshold number in order to enumerate the attribute value. Other approaches for whether to enumerate are possible. For instance, the enumeration criteria could incorporate a timing aspect that controls whether the attribute value is enumerated based at least in part on a lapse of an amount of time or a caching mechanism that is based on recency of observing instances of the attribute value and other attribute values. In the former approach, frequency of the receipt of the attribute value based on a specific amount of time can dictate whether to enumerate the value. For instance, a timer can be started and enumeration will occur if the value is received a threshold number of times before the timer lapses. In the latter approach, a cache or other structure is maintained to maintain or discard values therefrom based on recency of their receipt relative to other attribute values. Values can age-out of the cache based on the frequency at which other attribute values – either those for the same attribute or more generally across a collection of attributes – are received. A time-based decision-making approach could, in some examples, be facilitated by storing timestamp(s) (optionally in the data structure(s) containing he attribute values) for each attribute value, the timestamp(s) indicating a timing of receipt of the attribute value, for instance a time of the one or more most recent observations of the attribute value, as an example.

The process of FIG. 5 also includes (506) receiving request(s) to perform operation(s) on receives attribute value(s) and use enumeration(s) as applicable. For instance, based on a request to perform an operation on a received attribute value, of a data object, for which an enumeration is maintained, the process uses the enumeration of the received attribute value of the data object in performing the operation. Example operations include (i) a store operation to store the attribute value, where the enumeration of the attribute value (in the form of the value itself or a reference to the value) is stored as part of the data object, (ii) a read operation to read the attribute value of the data object, where the enumeration of the attribute value is read and provided, or (iii) an update operation to update the attribute value of the data object, where the enumeration of the attribute value (in the form of the value itself or a reference to the value) is used to replace an initial value for the attribute in the data object. In accordance with these aspects, processing can work with the enumeration of an attribute value performing an operation on the attribute value. An example such operation is performed when a new data object for storage is received and the attribute value (in non-enumerated form) is observed for an attribute of the object. The process can check the table(s) or other data structures in accordance with aspects described herein, identify that the attribute value has been enumerated, and then use the enumeration (the enumerated/numerical version of the non-enumerated attribute value) directly (or by way of a reference to the enumeration) when storing that new object to the datastore. Alternatively, as indicated, the operation could be one to read or update the attribute value for an already-maintained data object. For instance, an update attribute value request might be received and indicate a new attribute value to replace the existing attribute value for the data object. In this case, or if the attribute value for the attribute of a stored data object is to be read, the enumeration of the attribute value can be used for that operation, for example to replace the existing attribute value in the case of an update operation or to return the read attribute value in the case of a read operation.

In addition, one or more data structure(s), which could be the same or different from those maintaining the attribute values, could maintain information about attributes (by attribute name). Example such structures are attribute tables (also referred to as attribute name tables). Thus, an example process can further include maintaining an attribute table that maintains information for each attribute of a plurality of attributes of the data objects. The information could include, for each such attribute, one or more counts and an enumeration flag, the enumeration flag for an attribute of the plurality of attributes indicating whether to skip enumeration of attribute values of the attribute. The enumeration flag can provide another level of control over enumeration of attribute values. For instance, it might be determined that the uniqueness of the attribute values received for a given attribute is high enough (meaning the observed attribute values tend to differ from each other) that enumeration processing should be skipped for that attribute entirely. In a specific embodiment, the one or more counts maintained for an attribute include a first count, the first count being of a total number of instances of receiving any attribute value for the attribute, and a second count, the second count being of a number of unique attribute values received for the attribute. Whether to enable skip enumeration, meaning whether to skip the enumeration processing that will track attribute value instances and determine whether to enumerate, or if enumeration exists can be a function of the two counts. For instance, if the ratio of unique values to total instances is relatively high (above some threshold), it may be determined that enumeration processing is not worth it and that it should be skipped.

When a new attribute is seen, the enumeration flag can be set to enable enumeration processing (i.e., Skip Enumeration? = NO) to allow attribute values of that attribute to be tracked and potentially enumerated, for instance if their individual enumeration criteria are satisfied. Processing can monitor the total instances count and the unique values count for each attribute and decide whether that enumeration flag should be adjusted to disable enumeration processing (if enabled) or enable enumeration processing (if disabled). It might be decided to skip enumeration for an attribute at some point if the attribute values observed for the attribute are becoming unique enough (based on a threshold for example) to make it inefficient to expend resources on the enumeration processing at all. Conversely, if the attribute values observed for an attribute for which enumeration is being skipped become decreasing unique (i.e., observed with more repeating non-enumerating attribute values), the enumeration processing could be enabled for that attribute to track and potentially enumerate one or more attribute values being received for that attribute.

Related to the resource cost for enumeration processing, in some embodiments the maintaining of the at least some of the attribute values in the data structure(s) includes calculating hashes of these values, and the storing the enumeration of each enumerated attribute value stores the enumeration of the attribute value with a respective calculated hash of the attribute value. Maintaining non-enumerated attribute values in hash form can increase processing speed and reduce storage consumption. It is also noted that maintaining the at least some of the attribute values in the data structure(s) could include maintaining multiple data structures to house attribute values in different structures depending on their enumeration status. The maintenance of the structures could maintain, for example, a temporary table in volatile storage and a persistent table in non-volatile storage, where the at least some of the received attribute values are maintained at least initially (for instance up to the point if/when they become enumerated) in the temporary table in calculated hash form, and then, for any attribute value that is enumerated, is maintained along with an enumeration of that attribute value in the persistent table that is made persistent in the non-volatile storage. In this manner, enumerations can be made to persist in case of a server failure or other condition, while only temporary/volatile storage may be used for tracking attribute values that are not yet enumerated. The idea is that, until an attribute value is enumerated, the value of the tracking data related to observed instances of that attribute value may be insignificant enough that it is not worth persisting that data.

Attribute values stored in non-enumerated form may be targets for replacement with the enumerations of those values and optionally an active de-duplication of those stored, non-enumerated values. For example, they can be replaced with the actual enumeration or a reference to the enumeration. In one specific approach, a process crawls the stored attribute values for data objects in a data store and replaces non-enumerated values with enumerations of those vales, if they have been enumerated. In other words, the process can search for stored data objects having an enumerated attribute value stored therein as a non-enumerated value, and replace the non-enumerated value in the stored data objects with the enumeration of the attribute value (directly with the enumeration or with a reference to the enumeration). In this manner, once an attribute value is enumerated, the process could go and update all of the objects that have the attribute value in non-enumerated form, which could be all instances of the attribute value if the value has never previously been enumerated in the system, to replace the non-enumerated attribute value with the enumeration of the value. This processing could be done offline if desired, and based on a periodic scan of the objects for example, or potentially could be triggered when the enumeration decision is made to enumerate the value and the enumeration is generated.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
receiving attribute values for attributes of data objects, the received attribute values being non-enumerated values;
maintaining at least some of the attribute values in one or more data structures, wherein the maintaining the at least some of the attribute values comprises enumerating an attribute value, of the at least some of the attribute values, based on enumeration criteria, the enumerating comprising providing and storing an enumeration of the attribute value; and
based on a request to perform an operation on a received attribute value, of a data object, for which an enumeration is maintained, using the enumeration of the received attribute value of the data object in performing the operation.

2. The method of claim 1, further comprising maintaining an attribute table that maintains, for each attribute of a plurality of attributes of the data objects, one or more counts and an enumeration flag, the enumeration flag for an attribute of the plurality of attributes indicating whether to skip enumeration of attribute values of the attribute.

3. The method of claim 2, wherein the one or more counts maintained for the attribute comprise (i) a first count, the first count being of a total number of instances of receiving any attribute value for the attribute, and (ii) a second count, the second count being of a number of unique attribute values received for the attribute.

4. The method of claim 1, wherein the maintaining the attribute values further comprises maintaining, for each of the at least some of the attribute values, (i) a count of a number of instances that the attribute value was received and (ii) an enumeration indicator indicating whether the attribute value is enumerated.

5. The method of claim 4, wherein the maintaining the attribute value further comprises determining whether to enumerate the attribute value based on the enumeration criteria and the count of the number of instances that the attribute value was received.

6. The method of claim 4, wherein the enumeration criteria incorporates a timing aspect that controls whether the attribute value is enumerated based at least in part on (i) a lapse of an amount of time or (ii) a caching mechanism that is based on recency of observing instances of the attribute value and other attribute values.

7. The method of claim 1, wherein the operation comprises:
a store operation to store the attribute value, wherein the enumeration of the attribute value is stored as part of the data object;
a read operation to read the attribute value of the data object, wherein the enumeration of the attribute value is read and provided; or
an update operation to update the attribute value of the data object, wherein the enumeration of the attribute value is used to replace an initial value for the attribute in the data object.

8. The method of claim 1, wherein the maintaining the at least some of the attribute values comprises calculating hashes of the at least some of the attribute values, wherein the storing the enumeration of the attribute value stores the enumeration of the attribute value with a calculated hash of the attribute value.

9. The method of claim 8, wherein the maintaining the at least some of the attribute values in one or more data structures comprises maintaining a temporary table in volatile storage and a persistent table in non-volatile storage, wherein the at least some of the received attribute values are maintained at least initially in the temporary table in calculated hash form, and wherein any attribute value that is enumerated is maintained along with an enumeration of that attribute value in the persistent table, the persistent table being made persistent in the non-volatile storage.

10. The method of claim 1, further comprising searching for stored data objects having the attribute value stored therein as a non-enumerated value, and replacing the non-enumerated value in the stored data objects with the enumeration of the attribute value.

11. A computer system comprising:
at least one computing device;
a set of one or more computer readable storage media; and
program instructions, collectively stored in the set of one or more computer readable storage media, for causing the at least one computing device to perform computer operations including:
receiving attribute values for attributes of data objects, the received attribute values being non-enumerated values;
maintaining at least some of the attribute values in one or more data structures, wherein the maintaining the at least some of the attribute values comprises enumerating an attribute value, of the at least some of the attribute values, based on enumeration criteria, the enumerating comprising providing and storing an enumeration of the attribute value; and
based on a request to perform an operation on a received attribute value, of a data object, for which an enumeration is maintained, using the enumeration of the received attribute value of the data object in performing the operation.

12. The computer system of claim 11, wherein the computer operations further include maintaining an attribute table that maintains, for each attribute of a plurality of attributes of the data objects, one or more counts and an enumeration flag, the enumeration flag for an attribute of the plurality of attributes indicating whether to skip enumeration of attribute values of the attribute, wherein the one or more counts maintained for the attribute comprise (i) a first count, the first count being of a total number of instances of receiving any attribute value for the attribute, and (ii) a second count, the second count being of a number of unique attribute values received for the attribute.

13. The computer system of claim 11, wherein the maintaining the attribute values further comprises maintaining, for each of the at least some of the attribute values, (i) a count of a number of instances that the attribute value was received and (ii) an enumeration indicator indicating whether the attribute value is enumerated, and wherein the maintaining the attribute value further comprises determining whether to enumerate the attribute value based on the enumeration criteria and the count of the number of instances that the attribute value was received.

14. The computer system of claim 11, wherein the maintaining the attribute values further comprises maintaining, for each of the at least some of the attribute values, (i) a count of a number of instances that the attribute value was received and (ii) an enumeration indicator indicating whether the attribute value is enumerated, and wherein the enumeration criteria incorporates a timing aspect that controls whether the attribute value is enumerated based at least in part on (i) a lapse of an amount of time or (ii) a caching mechanism that is based on recency of observing instances of the attribute value and other attribute values.

15. The computer system of claim 11, wherein the maintaining the at least some of the attribute values comprises calculating hashes of the at least some of the attribute values, wherein the storing the enumeration of the attribute value stores the enumeration of the attribute value with a calculated hash of the attribute value, wherein the maintaining the at least some of the attribute values in one or more data structures comprises maintaining a temporary table in volatile storage and a persistent table in non-volatile storage, wherein the at least some of the received attribute values are maintained at least initially in the temporary table in calculated hash form, and wherein any attribute value that is enumerated is maintained along with an enumeration of that attribute value in the persistent table, the persistent table being made persistent in the non-volatile storage.

16. A computer program product comprising:
a set of one or more computer readable storage media; and
program instructions, collectively stored in the set of one or more computer readable storage media, for causing at least one computing device to perform computer operations including:
receiving attribute values for attributes of data objects, the received attribute values being non-enumerated values;
maintaining at least some of the attribute values in one or more data structures, wherein the maintaining the at least some of the attribute values comprises enumerating an attribute value, of the at least some of the attribute values, based on enumeration criteria, the enumerating comprising providing and storing an enumeration of the attribute value; and
based on a request to perform an operation on a received attribute value, of a data object, for which an enumeration is maintained, using the enumeration of the received attribute value of the data object in performing the operation.

17. The computer program product of claim 16, wherein the method further comprises maintaining an attribute table that maintains, for each attribute of a plurality of attributes of the data objects, one or more counts and an enumeration flag, the enumeration flag for an attribute of the plurality of attributes indicating whether to skip enumeration of attribute values of the attribute, wherein the one or more counts maintained for the attribute comprise (i) a first count, the first count being of a total number of instances of receiving any attribute value for the attribute, and (ii) a second count, the second count being of a number of unique attribute values received for the attribute.

18. The computer program product of claim 16, wherein the maintaining the attribute values further comprises maintaining, for each of the at least some of the attribute values, (i) a count of a number of instances that the attribute value was received and (ii) an enumeration indicator indicating whether the attribute value is enumerated, and wherein the maintaining the attribute value further comprises determining whether to enumerate the attribute value based on the enumeration criteria and the count of the number of instances that the attribute value was received.

19. The computer program product of claim 16, wherein the maintaining the attribute values further comprises maintaining, for each of the at least some of the attribute values, (i) a count of a number of instances that the attribute value was received and (ii) an enumeration indicator indicating whether the attribute value is enumerated, and wherein the enumeration criteria incorporates a timing aspect that controls whether the attribute value is enumerated based at least in part on (i) a lapse of an amount of time or (ii) a caching mechanism that is based on recency of observing instances of the attribute value and other attribute values.

20. The computer program product of claim 16, wherein the maintaining the at least some of the attribute values comprises calculating hashes of the at least some of the attribute values, wherein the storing the enumeration of the attribute value stores the enumeration of the attribute value with a calculated hash of the attribute value, wherein the maintaining the at least some of the attribute values in one or more data structures comprises maintaining a temporary table in volatile storage and a persistent table in non-volatile storage, wherein the at least some of the received attribute values are maintained at least initially in the temporary table in calculated hash form, and wherein any attribute value that is enumerated is maintained along with an enumeration of that attribute value in the persistent table, the persistent table being made persistent in the non-volatile storage.
